(19) United States
(12) Patent Application Publication
(10) Pub. No.: US 2004/0165672 A1
(43) Pub. Date: Aug. 26, 2004

(54) Upstream communication system with controllable band pass filter properties

(76) Inventor: Arnold Karel Jansen Van Doorn, Utrecht (NL)

Correspondence Address: Philips Electronics North America Corporation, Corporate Patent Counsel, PO Box 3001, Briarcliff Manor, NY, 10510, US

(21) Appl. No.: 10/480,348

(22) PCT Filed: Jun. 18, 2002
(86) PCT No.: PCT/IB02/02322

(30) Foreign Application Priority Data
Jun. 21, 2001 (EP) 01202408.9

(51) Int. Cl. H04L 27/00

(52) U.S. Cl. 375/259

(57) ABSTRACT

A communication system (1) is described in a possible embodiment comprising a main transmitter (TR) having two or more series arrangements of at least a digital signal processor (6) and a down sampler (7) coupled to the band pass filter (6), and having a multiplexer (MUX) coupled to each of the series arrangements and to a communication channel (CHUS, CHDS), and a main receiver (RC) having two ore more further series arrangements of at least an up sampler (9) and a further digital signal processor (10) coupled to the up sampler (9), and having a demultiplexer (DEMUX) coupled to the communication channel (CHUS, CHDS) and to each of the further series arrangements. Such a system is used for upstream transmission in a Hybrid Fiber Coax (HFC) network within specified frequency bands. The described system (1) provides extended flexibility to allow error reduced upstream transmission at an increased data rate. Control means (8, 11) provide adjustment of the digital signal processor parameters after installation of the system (1).

The present invention relates to a receiver for application in a communication system, which comprises a transmitter and the receiver coupled to the transmitter through a communication channel, the receiver includes: an up sampler having a sampling rate factor larger than one, and a first digital signal processor coupled to the up sampler.

The present invention also relates to a transmitter for in a communication system comprising a receiver and the transmitter coupled to the receiver through a communication channel.

In addition the present invention relates to a communication system provided with a transmitter and a receiver. Furthermore the present invention relates to programmable control means for application in the communication system.

A communication system using digital signal processing involving up sampling and down sampling, and acknowledged in the precharacterising portions of claims 1, 4 and 7 respectively, is known from WO 97/28611. The known communication system comprises a broadband network unit acting as a receiver and at least one transmitter device. The devices known from this prior art document which are placed in the residences, may be computer or cable modems, set-top boxes, communication equipment, such as telephones, and the like. The broadband network unit and the devices are coupled through a coaxial or twisted pair communication channel. The broadband network unit sends data signals downstream over the communication channel to the devices, and the devices in turn are capable of communicating data signals upstream to the receiver. For both the downstream and the upstream channels, the data is modulated onto RF carriers. A method of network synchronisation is described, in which the carrier frequency and the data clock are generated from a master clock signal, and are both different integer multiples of a sub-harmonic of said master clock. A method of down conversion of a received data signal modulated onto a carrier frequency is described herein, which comprises the following steps when the carrier frequency is twice the data clock. At first a data signal received is sampled at a rate which is equal to four-thirds of said carrier frequency, then this sampled signal is multiplied by binary orthogonal representations of said upstream carrier frequency, then this signal is interpolated to generate an interpolated signal which has three output samples for every input sample, then this interpolated signal is low-pass filtered, followed by decimating this low-pass filtered signal to produce one base band sample for every eight input samples.

This method reduces the complexity and the amount of signal processing for down conversion of a radio frequency signal. The method provides a way to lower the sampling rate of the sampled RF signal to the minimum needed to represent the data modulated onto the RF carrier. The method is however not flexible with regard to the choice of the carrier frequency and the bandwidth of the received signal. In addition it requires synchronisation between data clock rate and carrier frequency.

Therefore it is an object of the present invention to provide a transmitter/receiver communication system provided with such a RF pass band signal sampling rate reduction scheme that the resulting system shows a great amount of flexibility regarding the lie of the pass band.

Thereto the receiver according to the invention is characterised in that the digital signal processor is capable of digitally filtering out a non aliased portion of the received data signal, and that the receiver further includes first filter control means coupled to the first digital signal processor for controlling the first digital signal processor to reconstruct the data signal.

Thereto the transmitter according to the invention is characterised in that the transmitter includes a second digital signal processor, a down sampler coupled to the second digital signal processor for retaining only a part of samples of a data input signal, and second filter control means coupled to the second digital signal processor for controlling the digital signal processing therein such that a non aliased portion of the data signal can be reconstructed by the receiver.

It is an advantage of both the transmitter and receiver according to the present invention, that the sampling rate reduction provides a more efficient use of the data capacity needed in the communication channel connecting the transmitter and receiver. An example of the use of the transmitter and receiver is the transmission of upstream signals in a Hybrid Fibre Coax (HFC) CATV systems for which the available frequency spectrum for upstream transmission ranges from 5 to 65. According to the Nyquist sampling theorem, a transmitter comprising a sampler needs to be operated at a sampling rate of at least 130 MHz to prevent aliasing. Because the lower part of the upstream frequency spectrum above 5 MHz is often impaired by ingress noise, only a frequency band of 30 MHz wide in the upper part of the upstream spectrum can advantageously be used for effective upstream data transmission. If the transmitter is designed for transmission of only this 30 MHz wide pass band, the minimum sampling rate needed to represent the signals in the pass band is reduced to 60 MHz and down sampling by a factor of two of the filtered samples. In the transmitter according to the invention, this reduction is achieved using digital filtering of the sampled input signal and down sampling of the filtered samples. As compared to the system without such sample rate reduction, the amount of data modulated onto upstream RF carriers that can be transmitted using the system with sample rate reduction will only be slightly reduced. The reason for this is that data transmission in the cleaner part of the upstream spectrum can use more efficient modulation schemes, whereas also the noisy lower part of the upstream band contains “forbidden frequencies” which cannot be used for upstream data transmission and therefore consume valuable bandwidth.

It is a further advantage of the transmitter and receiver according to the invention that the position of the pass band can be chosen arbitrarily within the available frequency spectrum. This is a desirable feature, for instance because ingress noise may affect different systems in a different way. For instance, the optimum position of the pass band can be different for different systems located at different regions within a city.

It is a still further advantage that the transmitter and receiver, as well as the digital communication system as a whole can deal with both European and US type systems and market segments. For Europe type CATV systems, the upstream band spans from 5 to 65 MHz, whereas for US type systems the upstream band spans from 5 to 42 MHz. As an example, a system according to the invention may be have its digital signal processor programmed such that its pass band ranges from 30 to 60 MHz for application in a Europe type CATV system, whereas it is programmed to have its pass band ranging from 12 to 42 MHz for application in a US type system.

It is another advantage of the transmitter and receiver according to the invention that the first and/or second digital signal processor features can be changed after installation thereof in the field by simply having the first and/or second control means adjust the wanted filter or frequency shift features. This way several different embodiments of the invention can be implemented. Apart from the controllable signal processing parameters, such as digital filter coefficients, the positioning of the pass band of such digital filters may be controlled at wish.

In the down sampler decimation is effected by retaining only a part of samples of the data input signal. In the example described above, the 30 MHz bandwidth of the filtered samples corresponds to less than a quarter of the sampling rate, so that only each second sample needs to be retained. In general, only each m-th sample needs to be retained if the bandwidth has been limited to less than a fraction 1/2 m of the original sample rate, resulting in a bit rate reduction m in the implemented embodiments, where in the embodiments detailed hereafter that factor is two.

Further embodiments of the respective transmitter and receiver according to the invention are characterised in that the digital signal processor is implemented by means of programmable logic. An embodiment of the communication system according to the invention is characterised in that both digital signal processors are implemented by means of programmable logic.

Programmable logic has the advantage that at wish a local program can be implemented to control the relevant featuring parameters of the digital signal processors or particularly digital band pass filter or filters. Simple implementation can be effected by using Programmable Logic Devices (PLD's) of Field Programmable Gate Arrays (FPGA's) with the possibility of flexibly tailoring the position of the upstream frequency band to the prescribed requirements.

Other embodiments of the receiver and transmitter according to the respective inventions are characterised in that the receiver comprises a digital to analog converter whose input is coupled to the first digital signal processor; and in that the transmitter respectively comprises an analog to digital converter, whose output is coupled to the second digital signal processor.

Advantageously the essential components of transmitter and receiver are constructed digitally, which eases implementation and processing by a processor controlled integrated circuit.

In addition digital upstream transmission over an increased distance via the transmission channel is possible. Furthermore US type and European type systems and associated markets can be addressed with a single programmable design.

A preferred embodiment of the communication system according to the invention is characterised in that first and second control means in the receiver and transmitter respectively are mutually coupled through a control channel.

It is an advantage of the communication system according to the invention that a very flexible communication system results, as changes and updates to the filter and/or frequency shift features can be communicated through the control channel. In particular these changes and updates can be downloaded into the programmable logic in either or both of the transmitter and receiver using for example a remote control unit in the receiver station.

A further preferred embodiment of the communication system according to the invention is characterised in that the communication system comprises:

a main transmitter having two or more series arrangements of at least the second digital signal processor and the down sampler coupled to the digital signal processor, and having a multiplexer coupled to a parallel arrangement of each of the series arrangements and to a communication channel; and

a main receiver comprising two ore more further series arrangements of at least the up sampler and the first digital signal processor coupled to the up sampler, and having a demultiplexer coupled to the communication channel and to a parallel arrangement of each of the further series arrangements.

It is an advantage of this embodiment of the communication system according to the invention that a complete time division multiplexing upstream communication system is provided to flexibly enhance performance and functionality of for example Central Antenna Television (CATV) systems.

At present the transmitter and receiver, as well as the communication system according to the invention will be elucidated further together with their additional advantages, while reference is being made to the appended drawing, wherein similar components are being referred to by means of the same reference numerals.

In the drawing:

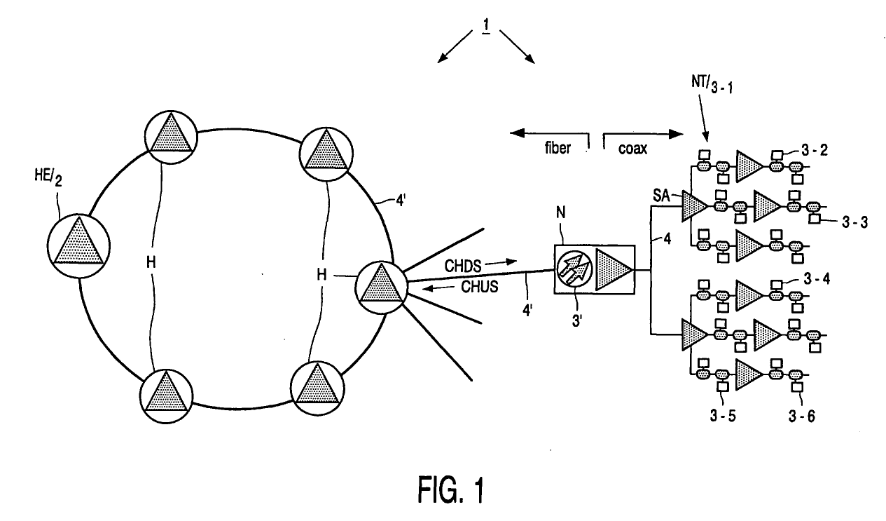

FIG. 1 shows a communication system for explaining the operation of the present invention;

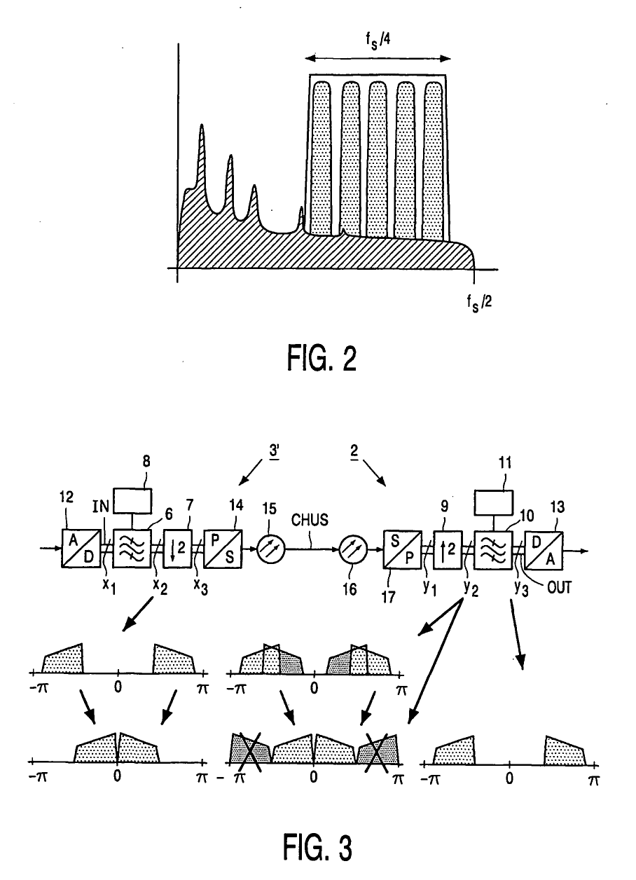

FIG. 2 shows the frequency spectrum and an example of the positioning of the upstream frequency band in the communication system according to the invention;

FIG. 3 shows a first possible embodiment of transmitter and receiver according to the invention for application in the communication system of FIG. 1;

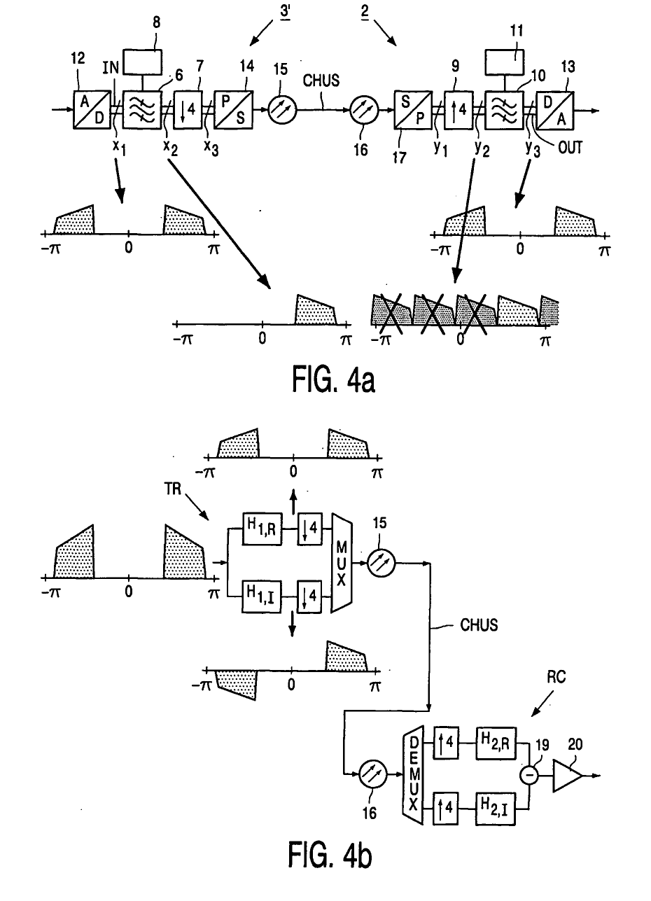

FIGS. 4a and 4b show a second possible embodiment of the transmitter and receiver according to the invention for application in the communication system of FIG. 1; and

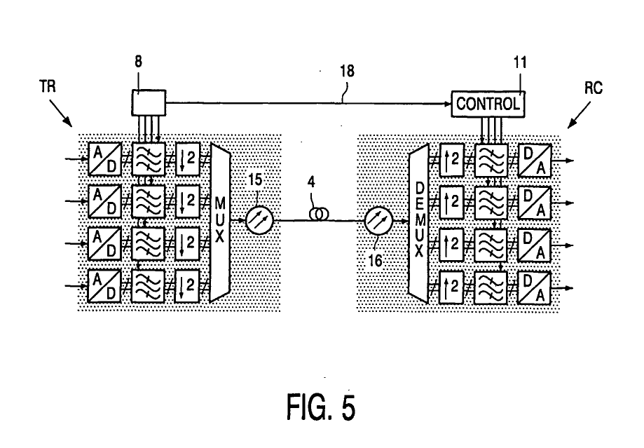

FIG. 5 shows an embodiment of a fully controlled communication system according to the invention.

FIG. 1 shows a communication system 1 having a station 2, also called Head-End (HE) optically coupled to so called Hubs H, which in turn are optically coupled to Nodes N. Each node N is coupled through a coax part 4 of a network 4′ and via splitters/amplifiers SA to stations 3-1, . . . 3-n, also called Network Terminals (NT). Head-end HE and nodes N are mutually coupled through a fiber part of the network 4′. The system 1 as shown is a HFC/CATV system wherein the head-end HE and the nodes N are capable of communicating through a Down Stream (CHDS) connection from HE to N, and through an Up Stream (CHUS) connection from N to HE.

In general, both the signals transported downstream and upstream will be subcarrier multiplexes of RF channels. Just by way of example, the downstream signal may consist of a mix of analogue TV channels and digitally modulated channels for reception by cable modems or set-top boxes in the residences. These cable modems or set-top boxes will modulate the NT user data onto RF carriers in the frequency band from 5-42 MHz (US-type systems) or 5-65 MHz (Europe-type systems). The upstream data signals from the residences connected to a single node are collected at the Node for transmission to the Head-End. The upstream signal transmitted from the Node will generally consist of multiple of such digitally modulated RF channels. The individual upstream channels may have different symbol rates as well as different modulation formats, for instance QPSK or 16-QAM. After transmission through the upstream connection CHUS, these data channels are demodulated in the Head-End for recovery of the originally sent data signals.

FIG. 2 gives an example of the frequency power spectrum and positioning of the upstream frequency band of the upstream connection CHUS in the communication system 1. It gives an example of the spectral signature of ingress noise (dashed area), of how a number of digitally modulated RF channels are positioned in the clean part of the upstream spectrum (grey blocks), and of the pass band of the factor two decimated system. When the input signal of the transmitter is sampled at a frequency fₛ, the bandwidth of the undecimated system ranges from 0 to fₛ/2. From the analogue response characteristics of the coaxial part of the HFC communication system, the frequency range from 0 to 5 MHz cannot be used for data transmission. Because a practical transmitter requires the use of an analogue anti-alias filter before the AD converter, the practical bandwidth of the system will be slightly less than fₛ/2. To achieve a practical bandwidth spanning up 65 MHz (Europe type systems), a sampling rate of at least 130 MHz is required.

In practice a viable approach for Europe type systems is to use an approximately 30 MHz band pass width, which constitutes a significant fraction of the “clean” part of spectrum. In this clean part of the spectrum spectrally more efficient modulation schemes can be used, whereas also the RF carriers can be stacked denser than in the noisy lower part of the spectrum. Because the 30 MHz width of the pass band is less than fₛ/4, it is in principle possible to reduce the sampling rate to fₛ/2, i.e. to decimate the original sampled signal by a factor of two. When two of such decimated signals are multiplexed together, the bit rate of the upstream channel will have the same serial bit rate as for a single undecimated system. If, for both upstream channels, the pass band is positioned such as to exclude either the unusable spectrum near 0 or that near fₛ/2 such a system will have a larger total RF bandwidth available for data transmission than a single undecimated system. If the band pass regions of the decimated system coincide with the clean parts of the upstream band, then the factor two decimated system certainly will have a higher capacity for data transmission than the not decimated system.

FIG. 3 shows a first embodiment of how to arrange the transmitting node station N and the receiving station at HE or H in the communication system 1 of FIG. 1. The node N comprises a transmitter generally indicated 3′, which includes a digital signal processor 6, a down sampler 7 coupled to the signal processor 6, and filter control means 8 coupled to the processor 6. The head-end 2 in turn comprises an up sampler 9, a further digital signal processor 10 coupled to the up sampler 9, and filter control means 11 coupled to the further processor 10. Appropriate analog-to digital (AD) and digital-to analog (DA) convertors 12 and 13 respectively are coupled to input IN and output OUT of the respective digital signal processors 6 and 10 respectively.

The operation of the upstream communication between the transmitter 3′ in node N and the receiver 2 in head-end HE or hub H, as shown in FIG. 3 is as follows. An analog transmitter input signal is AD converted in AD converter 12 and then fed as digital data input signal x₁ to digital signal processor 6. Processor 6 acts as an anti-aliasing filter, that is it acts as a band pass filter which has a width of at most fₛ/4 as shown in FIG. 2. The output signal x₂ from this signal processor 6, whose frequency spectrum is shown directly under the associated arrow is then down-sampled (=decimated) by a factor of in this embodiment two, i.e. only each second sample of x₂ is retained in x₃. As shown the signal x₃ is here then serialised in parallel-to-series converter 14, modulated in modulator 15 and then transmitted via the upstream channel CHUS to the head-end 2. After receipt in the head-end the data signal is demodulated in demodulator 16, deserialised in series-to parallel converter 17, and then up sampled (=interpolated) in up sampler 9 for inserting zeros between consecutive data signal samples. The up sampled signal y₂ is identical to the signal x₂ but with each second sample replaced by a zero. The spectrum of y₂ consists of the spectrum of x₂ whereto in general shifted images of x₂ are added, which is schematically shown at the right of the spectrum of the signal x₂. It shows that aliasing results unless proper measures are taken. The control means 8 and 11 are for controlling the digital processor filter characteristics in the filter processors 6 and 10 respectively and/or as far as necessary for avoiding aliasing to effect a processor frequency conversion or frequency shift. The frequency shift by the processor 6 in this case is such that the spectrum of x₂ is changed into the spectrum of x₂ shown thereunder, wherein the spectra are shifted to one another. The result thereof for the signal y₂ at the receiver end is that the overlapping spectra no longer overlap and aliasing is avoided (see spectrum of y₂ mid under in FIG. 3). The processor 10 is a filter and frequency converter, which is now controlled such that the spectra are separated and shifted in order to yield the reconstructed wanted data signal (outer right), which is similar to x₂.

FIGS. 4a and 4b show a second embodiment of the communication system 1. Similarly numbered blocks again refer to similar functions. However in this scheme starting from input signal x₁ at input IN the digital signal processor 6 constructs a single side band representation in the form of signal x₂ as shown at the end of the corresponding arrow thereof. The resulting spectral content of x₂ is now limited to a single frequency band having width 2π/4. Now four fold down sampling can be applied in down sampler 7. The corresponding up sampler 9 places three subsequent zeros after each incoming sample. The spectrum of signal y₂ is now found by using M=4 in the expression relating to the spectrum Y(e^{iθ}) of the M fold down and up sampled signal to the spectrum X(e^{iθ}) before down and up sampling, following:

M−1

Y(e^{iθ})=(1/M)·ΣX(e^{i(θ-2Πν/M)}) (1)

ν=0

assuming that the normalised frequency: θ=2Πf/fₛ. Reconstruction of the original input signal x₁ now firstly consists of reconstructing the single side band signal x₂ by means of the upsampler 9, which by interpolation suppresses the three image spectra in y₂ as shown. Subsequently, the output signal y₃ at output OUT of signal processor 10 is constructed from this interpolated single side band signal before being fed to the DA converter 13.

A practical implementation of the basic scheme of FIG. 4a is elucidated in FIG. 4b. Denoting the transfer function of the complex anti aliasing processor 6 by H₁, then its real and imaginary branches H_{1,R} and H_{1,I} are given by:

H_{1,R}(e^{iθ})=(1/2)·(H₁(e^{iθ})+H₁(e^{-iθ}))

H_{1,I}(e^{iθ})=(1/2i)·(H₁(e^{iθ})−H₁(e^{-iθ}))

Similarly the transfer function H₂ of the digital processor 10, that is its real and imaginary parts can be found. At the transmitter end TR the real and imaginary signals as shown at top and bottom side of FIG. 4b are down sampled and multiplexed in multiplexer MUX and thereafter modulated, transmitted through channel CHUS and then demultiplexed in demultiplexer DEMUX. Again at the receiver end RC there are similar parallel up sample and filter branches. The output signal at the real and imaginary filter outputs are fed to a subtracter 19. In order to reconstruct the original signal also with respect to its amplitude a multiplicator 20 multiplies the resulting signal by a factor of 2M=8. The factor of two arises because the desired signal can be considered as twice the real part of the single side band signal, and the factor M arises to correct for the gain factor 1/M in equation (1) above. For fiber optic transmission the down sampled signals of the real and imaginary branches are multiplexed together. The bit rate reduction is therefore a factor two, making it equal to that achieved with the scheme of FIG. 3. The scheme in FIGS. 4a and 4b can in fact be seen as a simplified version of the scheme of FIG. 3. The former scheme lacks frequency translation steps in node transmitter 3′ and head-end receiver station 2. The scheme shows a smaller number of filter steps, and also the filter needed at the receiver end is significantly simplified for the intended use of the system.

FIG. 5 shows an embodiment of a fully controlled communication system 1. Although the control means 8 and 11 may stand alone, programmed properly to effect band pass filtering at an adequate position in the frequency domain and having a required pass band width and/or to effect a wanted frequency shift to avoid aliasing, the control means 8 and 11 may be coupled to one another as shown in the communication system 1 of FIG. 5. In that case adequate control parameters can be exchanged over a control channel 18 present between the means 8 and 11. At wish control parameters can be updated and/or downloaded from some external filter control parameter source (not shown). It is preferred in each the aforementioned embodiments to implement the respective digital processors 6 and 10 in programmable logic.

The system as shown in FIG. 5 comprises what is here called a main transmitter TR in the node N, here having four series arrangements of consecutively A/D converter, controllable digital signal processor and down sampler (reference numerals omitted for clarity), and having a multiplexer MUX coupling the parallel arrangement of series arrangements. Multiplexer MUX is coupled to communication channel via modulator 15. The system similarly comprises a main receiver RC in the hub H or head-end HE, comprising four series arrangements of consecutively up sampler, digital signal processor and DA converter, and having a demultiplexer DEMUX coupled to the communication channel via demodulator 16. The communication system 1 whose basic operation is explained above is capable of combining four separate connections by using time division multiplexing. With a sampling rate of 125 MHz and an 8 bit resolution for each of the decimated signals, the serial bit rate of the multiplexed stream will be 2 Gbps.

The above mentioned sampling rate factors need not necessarily be integer numbers. The man skilled in the relevant art is capable of implementing samplers having rational sampling rate factors.

Whilst the above has been described with reference to essentially preferred embodiments and best possible modes it will be understood that these embodiments are by no means to be construed as limiting examples of the stations and system concerned, because various modifications, features and combination of features falling within the scope of the appended claims are now within reach of the skilled person.

1. A receiver (2) for application in a communication system (1), which comprises a transmitter (3′) and the receiver (2) coupled to the transmitter (3′) through a communication channel (CHUS, CHDS), the receiver (2) includes: an up sampler (9) having a sampling rate factor larger than one, and—a first digital signal processor (10) coupled to the up sampler (9), characterised in that the digital signal processor (10) is capable of digitally filtering out a non aliased portion of the received data signal, and that the receiver (2) further includes first filter control means (11) coupled to the first digital signal processor (10) for controlling the first digital signal processor (10) to reconstruct the data signal.

2. The receiver (2) according to claim 1, characterised in that the first digital signal processor (10) is implemented by means of programmable logic.

3. The receiver (2) according to one of the claims 1 or 2, characterised in that the receiver (2) comprises an digital to analog converter (13), whose input is coupled to an output (OUT) of the first digital signal processor (10).

4. A transmitter (3′) for application in a communication system (1) comprising a receiver (2) and the transmitter (3′) coupled to the receiver (2) through a communication channel (CHUS, CHDS), characterised in that the transmitter (3′) includes a second digital signal processor (6), a down sampler (7) coupled to the second digital signal processor (6) for retaining only a part of samples of a data input signal, and second filter control means (8) coupled to the second digital signal processor (6) for controlling the digital signal processing therein such that a non aliased portion of the data signal can be reconstructed by the receiver (2).

5. The transmitter (3) according to claim 4, characterised in that the second digital signal processor (6) is implemented by means of programmable logic.

6. The transmitter (3′) according to one of the claims 4 or 5, characterised in that the transmitter (3′) comprises an analog to digital converter (12), whose output is coupled to the digital signal processor (6).

7. A communication system (1) comprising a transmitter (3′) according to one of the claims 4-6 and a receiver (2) according to one of the claims 1-3.

8. A communication system (1) according to claim 7, characterised in that first and second control means (8, 11) in the receiver (2) and transmitter (3′) respectively are mutually coupled through a control channel (18).

9. The communication system (1) according to claim 7 or 8, characterised in that both digital signal processors (6, 10) are implemented by means of programmable logic.

10. The communication system (1) according to one of the claims 7-9, characterised in that the communication system (1) comprises:—a main transmitter (TR) having two or more series arrangements of at least the second digital signal processor (6) and the down sampler (7) coupled to the digital signal processor (6), and having a multiplexer (MUX) coupled to a parallel arrangement of each of the series arrangements and to a communication channel (CHUS, CHDS); and—a main receiver (RC) comprising two ore more further series arrangements of at least the up sampler (9) and the first digital signal processor (10) coupled to the up sampler (9), and having a demultiplexer (DEMUX) coupled to the communication channel (CHUS, CHDS) and to a parallel arrangement of each of the further series arrangements.

11. Programmable control means (8, 11) for application in the communication system (1) according to one of the claims 7-11.
